(19) United States
(12) Patent Application Publication
(10) Pub. No.: US 2006/0266788 A1
(43) Pub. Date: Nov. 30, 2006

(54) ELECTRIC STAPLER

(75) Inventor: Tokinori Takada, Chiba (JP)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(73) Assignee: KTF CORPORATION, Tokyo (JP)

(21) Appl. No.: 11/462,492

(22) Filed: Aug. 4, 2006

(30) Foreign Application Priority Data
Apr. 15, 2005 (JP) 2005-118806

(51) Int. Cl. B25C 5/02

(52) U.S. Cl. 227/131

(57) ABSTRACT

An electric stapler is provided that performs stapling driven by electric power and is provided with a release button for operation at the time of reloading staples to release and eject a magazine frame retained under pressure. The electric stapler is provided on the magazine frame with at least one engagement projection and on a main unit with at least one engagement potion constituting a stop that engages with the engagement projection to control the ejection distance of the magazine frame so that the magazine frame is not ejected by an elastic body more forcefully than necessary upon operation of the release button.

### BACKGROUND OF THE INVENTION

1. Field of the Invention

The present invention relates an electric stapler for binding sheaves of documents or the like with staples (U-shaped fastening wires) utilizing electric power, particularly to an electric stapler equipped with at least one engagement portion and at least one engagement projection that prevent a frame energized by an elastic body from being ejected more forcefully than necessary at the time of staple reloading.

2. Description of Related Art

Staplers have long been widely used for binding sheaves of documents and the like to be filed. Although most staplers are manually operated, they require a strong pressing force when used to bind a tick sheaf. The electric stapler was therefore developed to provide a binding device to take the place of those requiring manual pressing by the user. The electric stapler is convenient to use because it enables automatic binding driven by electric power. A typical example of the electric stapler according to the prior art is disclosed in Japanese Unexamined Patent Publication No. 2000-317861.

This type of electric stapler is configured so that when a release switch (button) located at the rear or one side of the main unit is pressed to enable reloading of staples, a magazine frame is ejected outward by the force of an elastic body. Owing to the strong energizing force acting on the magazine frame, however, the entire frame pops out instantaneously when released. Since the resulting impact not only acts on magazine frame and but also propagates throughout the entire stapler, it is apt to cause damage in the course of repeated use. In addition, the user may suffer eye injury if he or she should happen to be looking into the ejection opening at the time the magazine fame pops out.

A need has therefore been felt for a safe electric stapler that minimizes impact by controlling the ejection distance of the magazine frame.

### SUMMARY OF THE INVENTION

An object of the present invention is to overcome the aforesaid problems by providing an electric stapler that controls the ejection distance of the magazine frame by providing at least one engagement projection at the free end of the magazine frame and at least one engagement portion at the ejection opening of the main unit.

The present invention achieves the foregoing object by providing an electric stapler that performs stapling driven by electric power and is provided with a release button for operation at the time of reloading staples to release and eject a magazine frame retained under pressure, which electric stapler is provided on the magazine frame with at least one engagement projection and on a main unit with at least one engagement portion constituting a stop that engages with the engagement projection to control the ejection distance of the magazine frame so that the magazine frame is not ejected by an elastic body more forcefully than necessary upon operation of the release button.

In addition, the electric stapler is formed on the side faces of the magazine frame at its forward end in the direction of movement with symmetrically positioned engagement projections standing perpendicular to the side faces and is formed on the side faces of the ejection opening of the main unit with a pair of engagement portions standing perpendicular to the inner faces thereof.

Owing to the aforesaid structure, the electric stapler according to the present invention has the following merits:

1. The engagement portions provided on the main unit to engage with the engagement projections of the magazine frame make it possible to control the ejection distance of the magazine frame so as to reduce impact and enhance safety.

2. The formation of the engagement projections at the forward end of the magazine frame and the formation of the engagement portions at the ejection opening enable the magazine frame to be promptly stopped when the release button is pressed.

### BRIEF DESCRIPTION OF THE DRAWINGS

FIG, 1 is an overall view of an electric stapler.

FIG. 2 is a side sectional view of the electric stapler with its magazine frame in the retracted position.

FIG. 3 is a side sectional view of the electric stapler with the engagement projection of the magazine frame engaged with the engagement portion of the main unit.

FIG. 4 is a plan sectional view of the electric stapler with the magazine frame in the retracted position.

FIG. 5 is a plan sectional view of the electric stapler with the engagement projection of the magazine frame engaged with the engagement portion of the main unit.

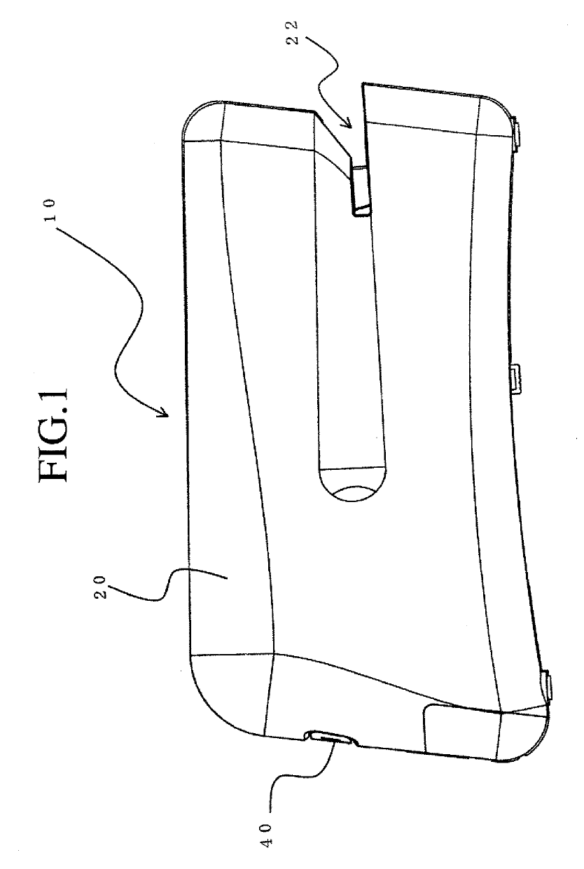

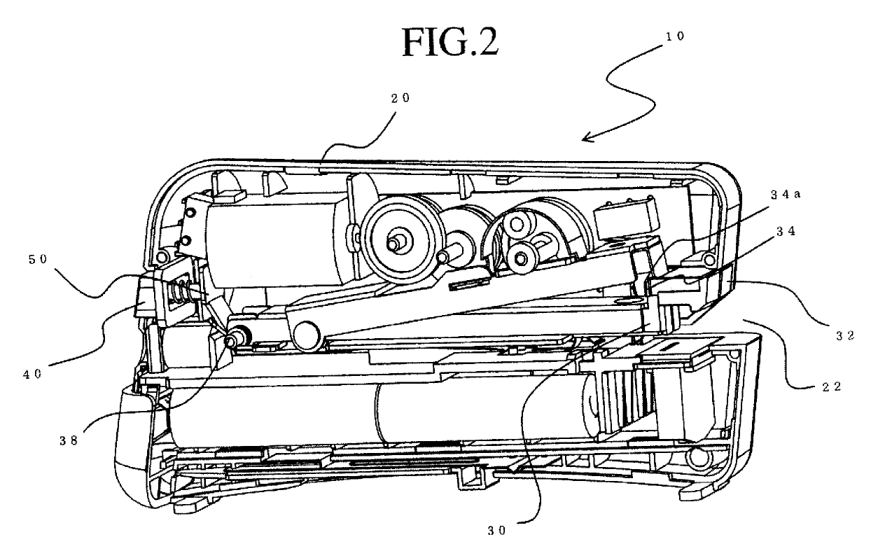

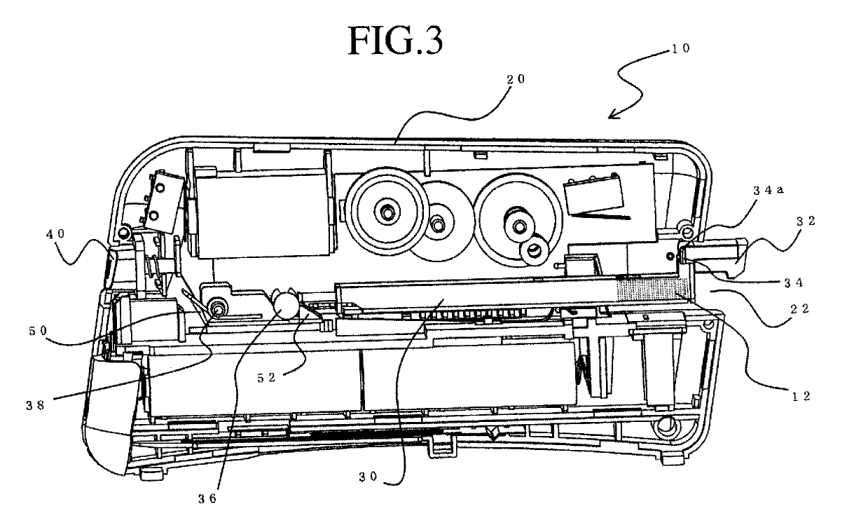

### DESCRIPTION OF THE PREFERRED EMBODIMENTS

The electric stapler according to the present invention will now be explained in detail with reference to an embodiment shown in the drawings.

The electric stapler, designated by the symbol 10 in the drawings, comprises a main unit 20, a drive section, a drive mechanism, a base section, a magazine frame 30, and a switch section.

The electric stapler 10 of the present invention is characterized by an engagement operation between the main unit 20 and magazine frame 30. The components constituting the remainder of the electric stapler are the same as those of the conventional electric stapler and will therefore not be explained in detail.

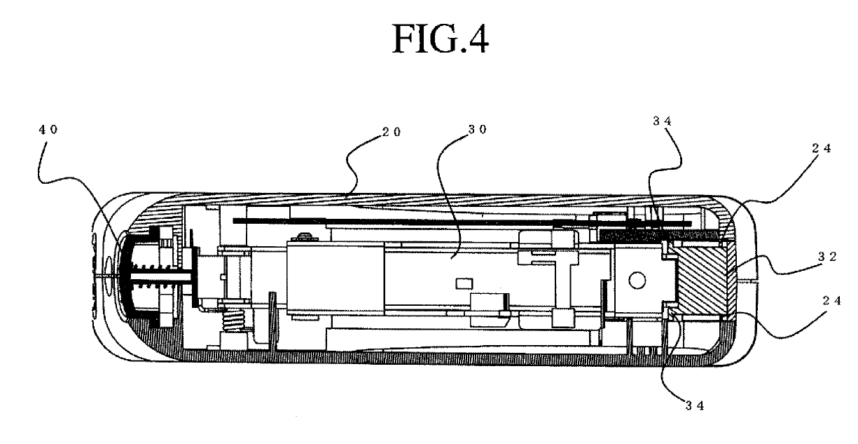

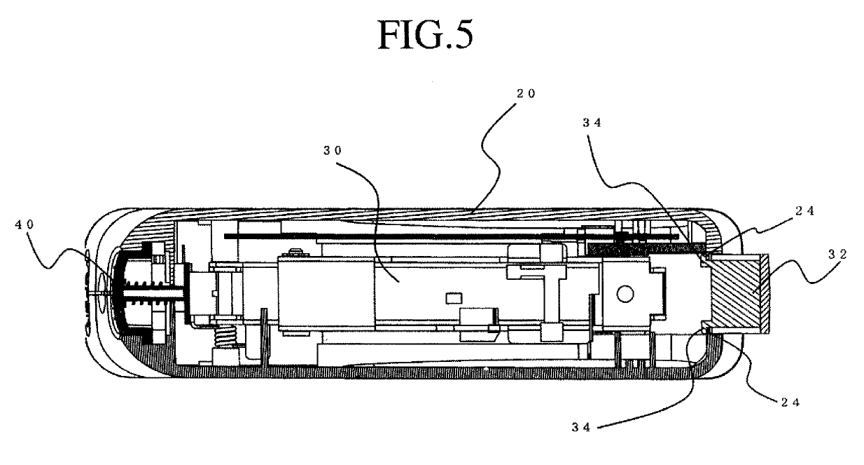

The main unit 20 is a frame body made of resin that encloses the constituent components housed inside the electric stapler 10, including, among others, the drive section, drive mechanism and magazine frame 30. As shown in the plan sectional views of FIGS. 4 and 5, engagement portions 24 are formed at the ejection opening 22 of the main unit 20. The engagement portions 24 are formed in a paired relationship on the side faces of the main unit ejection opening 22 so as to engage engagement projections 34 formed on the magazine frame 30.

The magazine frame 30 is mounted to be rotatable around a shaft 38 and accommodates staples 12. In this embodiment, the engagement projections 34 are formed one on either side face of the distal end 32 of the magazine frame 30. The proximal end of the magazine frame 30 is formed with an engagement member 36 coupled with a release member 50 explained later. In this embodiment, the magazine frame is divided into portions made of different materials, namely, its main portion is formed of metal and the distal end 32 of resin. However, it is also possible to integrate the distal end 32 with the magazine frame 30 in a unitary structure. As shown in the side and plan views, the engagement projections 34 are configured to engage with the engagement portions 24 when the magazine frame 30 ejects.

The operation of the electric stapler 10 of the present invention will now be explained in detail. When a release button 40 provided at the rear of the main unit 20 is pressed, the release member 50 is depressed to release the engagement between a projection 52 of the release member 50 and the engagement member 36 of the magazine frame 30. As a result the magazine frame 30 is ejected forward through the ejection opening 22 of the main unit 20 by an elastic body (not shown). Although in the conventionally structured electric stapler the whole magazine frame 30 is ejected, in the electric stapler according to the present invention the engagement of the engagement portions 24 with the engagement projections 34 of the magazine frame 30 keeps the magazine frame 30 from popping outward more than necessary. After the engagement is established, the magazine frame 30, whose distal end can move vertically, can be moved downward to release the engagement between the engagement portions 24 of the main unit 20 and the engagement projections 34 of the magazine frame 30, thereby making it possible to draw the entire magazine frame out.

In addition, in this embodiment the inner corners 34a at the top of the engagement projections 34 are rounded so that the magazine frame can be easily reinserted into the main unit. Further, although not visible in the drawings, the regions of the engagement portions 24 that make contact with the corners 34a are similarly rounded. This provision of the rounded regions allows the contacting corners to slide easily relative to each other, thereby facilitating reinsertion of the magazine frame in the main unit.

Although it was explained that the engagement members and engagement projections are provided at the distal end, it is instead possible in this invention to provide the engagement projections midway of the magazine frame and provide the engagement members on the main unit at corresponding locations. It is also possible to provide these members on only one side or to provide the prjection at an appropriate location. Although it was explained that the projections are formed perpendicularly, the present invention is not limited to this configuration.

In the conventional electric stapler, the entire magazine frame is ejected when the release button is pushed. However, the configuration in accordance with the present invention makes it possible to control the ejection distance of the magazine frame. and thus avoid occurrence of impacts that propagate throughout the electric stapler. The frequency of malfunctions is therefore reduced.

What is claimed is:

1. An electric stapler that performs stapling driven by electric power and is provided with a release button for operation at the time of reloading staples to release and eject a magazine frame retained under pressure, which electric stapler is provided on the magazine frame with at least one engagement projection and on a main unit with at least one engagement portion constituting a stop that engages with the engagement projection to control the ejection distance of the magazine frame so that the magazine fame is not ejected by an elastic body more forcefully than necessary upon operation of the release button.

2. The electric stapler according to claim 1, which is formed on the side faces of the magazine frame at its forward end in the direction of movement with symmetrically positioned engagement projections standing perpendicular to the side faces and is formed on the side faces of the ejection opening of the main unit with a pair of engagement portions standing perpendicular to the inner faces thereof.
